(19) United States
(12) Patent Application Publication
(10) Pub. No.: US 2003/0236717 A1
(43) Pub. Date: Dec. 25, 2003

(54) Packaging for internet access and method

(76) Inventors: Edward S. Honour, Schaumburg, IL (US); Joseph P. Abate, Carol Stream, IL (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/195,646

(22) Filed: Jul. 15, 2002

(51) Int. Cl. G06F 17/60

(52) U.S. Cl. 705/27

(57) ABSTRACT

An internet access package for retail sale is disclosed. The package includes a package having the appearance of packaging which is generally recognized by consumers as being associated with a particular product, and an access code packaged in conjunction with the packaging which is accessible to a consumer after the package is purchased. The access code enables such a consumer to access a restricted access site on a computer network. A consumer can purchase this product at a retail store such that access to the site is prepaid and anonymous. Also, the concern over security of an online transaction is vitiated. Preferably, the site pertains to the product to with which the packaging is related. A method of packaging and providing access to a restricted access site is also provided. Access is preferably provided for a limited time.

### TECHNICAL FIELD

The present invention relates to packaging for internet access, and more specifically packaging for internet access which is designed for retail sale which enables alternative methods of payment for accessing restricted access sites and a method regarding the same.

### BACKGROUND OF THE INVENTION

There are numerous internet sites which are restricted access sites. Many such sites require that a visitor make a payment in order to visit the restricted portions of the site. Such payments are typically made using the visitor's charge card, such as a credit or debit card.

There are several disadvantages to making payments online using a charge card. First, there may be some security issues or concerns that the account number will be accessed by a third party. Regardless of the merits of these concerns, the perception that security is an issue deters numerous visitors from conducting such a transaction.

Further disadvantages of using such a payment method include concerns about revealing the identity of the visitor, as well as visitors in some situations desiring that their activities remain unknown to others. In various situations, visitors will prefer or require that they conduct such transactions with anonymity. Utilizing charge cards online for obtaining access to such restricted access sites does not allow for a suitable level of anonymity.

Restricted access sites typically attract visitors via online advertisements, search engines, and other forms of advertising. Many online sites provide access to online products which are closely related to various retail products. For example, restricted access sites include online magazine subscriptions, online books, online access to music, software, video, webcasts, rebroadcasts of shows, etc. This marketing focus is deficient in that it neglects a large portions of the market, namely, the retail market.

Therefore, it would be advantageous to provide access to restricted access sites in a manner which enables the visitor to maintain anonymity. It would also be advantageous to provide a manner of packaging access to restricted access sites which would tap the retail market.

### SUMMARY

In view of the deficiencies described above, it is an object of the present invention to provide an improved method for providing access to restricted access sites. It is a further object of the present invention to provide a manner of packaging access to restricted access sites for the retail market.

In accordance with the above objectives, the present invention is an internet access package for retail sale. The package comprises a package having the appearance of packaging which is generally recognized by consumers as being associated with a particular product, and an access code packaged in conjunction with the packaging which is accessible to a consumer after the package is purchased. The access code enables such a consumer to access a restricted access site on a computer network. A consumer can purchase this product at a retail store such that access to the site it prepaid and anonymous. Also, the concern over security of an online transaction is vitiated.

In a preferred embodiment, the site is related to the product which is typically packaged via the packaging of the invention. Packaging for the present invention could be a magazine cover, a book cover, a CD case, a DVD case, a software box, packaging for a language education product, a cassette case, a video cassette case, etc. In this embodiment, the site would provide access to an online version of the product normally encompassed within the packaging. For example, access to an online magazine would be provided in a magazine cover package, or access to online music would be provided in a CD case or cassette case. Preferably, the packaging would not include the product normally associated therewith.

At the retail level, such packaging can be sold in a section of a store in which other products relating thereto are sold. For example, a magazine cover with the access code to an online magazine would be sold in a magazine section of the store. This enables the site owners to tap into the retail market for online access to the related online product.

The present invention a method for packaging and providing access to a restricted access site on a computer network comprising the steps of providing a package having the appearance of packaging which is generally recognized by consumers as being associated with a particular product, and providing an access code packaged in conjunction with the packaging which is accessible to a consumer after the package is purchased, wherein the access code enables such a consumer to access a restricted access site on a computer network.

Furthermore, the present invention encompasses a manner of updating and maintaining a restricted access site to which access is provided via the present invention. The process includes regularly or periodically updating the site with new material, and deleting material after it has been posted for a set period of time. As this process is continuously utilized, visitors will be interested as new material appears on the site, and will be motivated to purchase additional access to the site.

Other features and advantages of the invention will be apparent from the following detailed description taken in conjunction with the following drawings.

### BRIEF DESCRIPTION OF THE DRAWINGS

FIG. 1 is a perspective view of one embodiment of a shrink wrapped magazine cover of the present invention.

FIG. 2 is a perspective view of another embodiment of the package of the present invention.

FIG. 3 is a perspective view of another embodiment of the package of the present invention.

FIG. 4 is a perspective view of another embodiment of the package of the present invention.

FIG. 5 is a perspective view of another embodiment of the package of the present invention.

FIG. 6 is a perspective view of another embodiment of the package of the present invention.

FIG. 7 is a perspective view of another embodiment of the package of the present invention.

FIG. 8 is a perspective view of another embodiment of the package of the present invention.

FIG. 9 is a perspective view of another embodiment of the package of the present invention.

FIG. 10 is a perspective view of another embodiment of the package of the present invention.

FIG. 11 is a perspective view of another embodiment of the package of the present invention.

FIG. 12 is a perspective view of another embodiment of the package of the present invention.

FIG. 13 is a perspective view of another embodiment of the package of the present invention.

FIG. 14 is a perspective view of another embodiment of the package of the present invention.

FIG. 15 is a perspective view of another embodiment of the package of the present invention.

FIG. 16 is a perspective view of another embodiment of the package of the present invention.

FIG. 17 is a perspective view of another embodiment of the package of the present invention.

FIG. 18 is a perspective view of another embodiment of the package of the present invention.

FIG. 19 is a perspective view of another embodiment of the package of the present invention.

FIG. 20 is a perspective view of another embodiment of the package of the present invention.

FIG. 21 is a perspective view of another embodiment of the package of the present invention.

FIG. 22 is a perspective view of another embodiment of the package of the present invention.

FIG. 23 is a perspective view of another embodiment of the package of the present invention.

FIG. 24 is a perspective view of another embodiment of the package of the present invention.

FIG. 25 is an expanded view of an insert of the present invention.

FIG. 26 is a front view of a card insert of the present invention.

FIG. 27 is a perspective view of another embodiment of the package of the present invention.

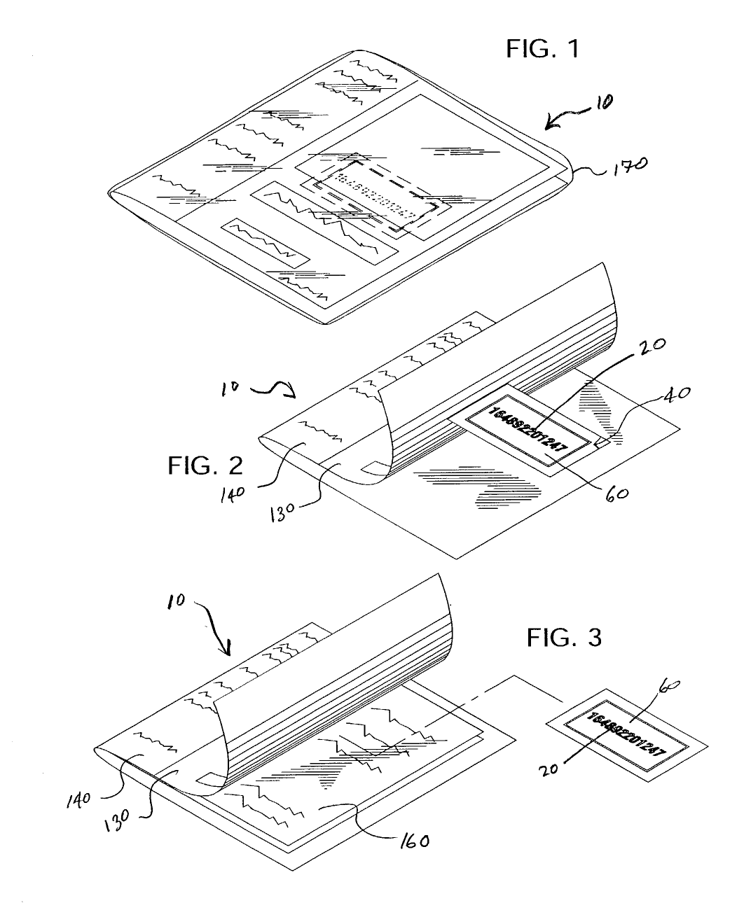

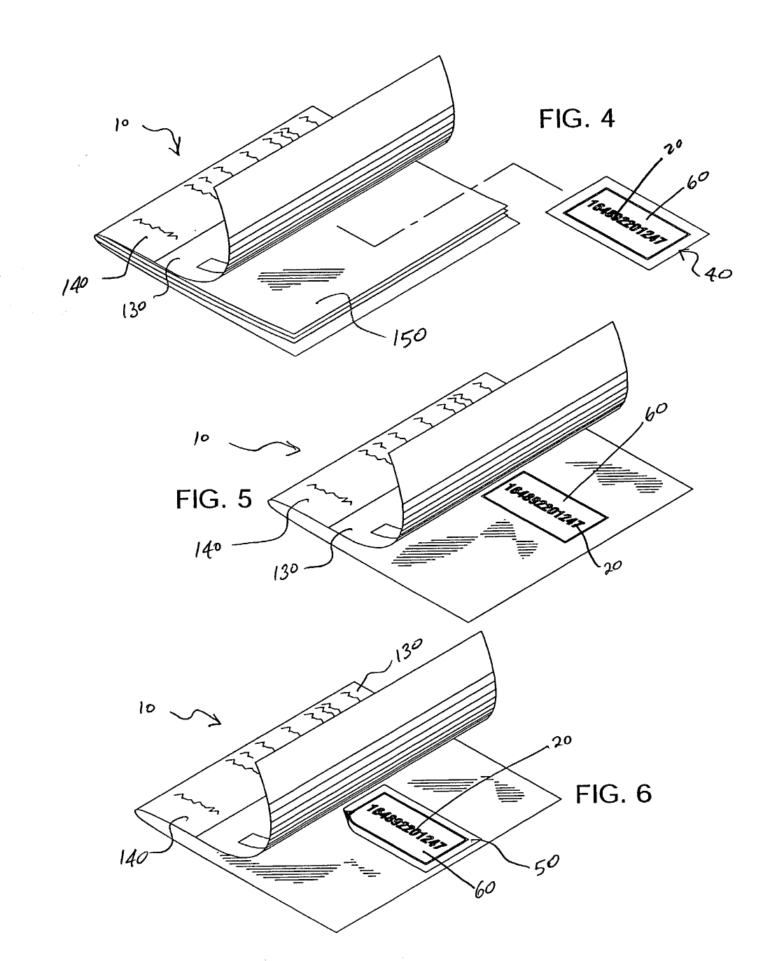

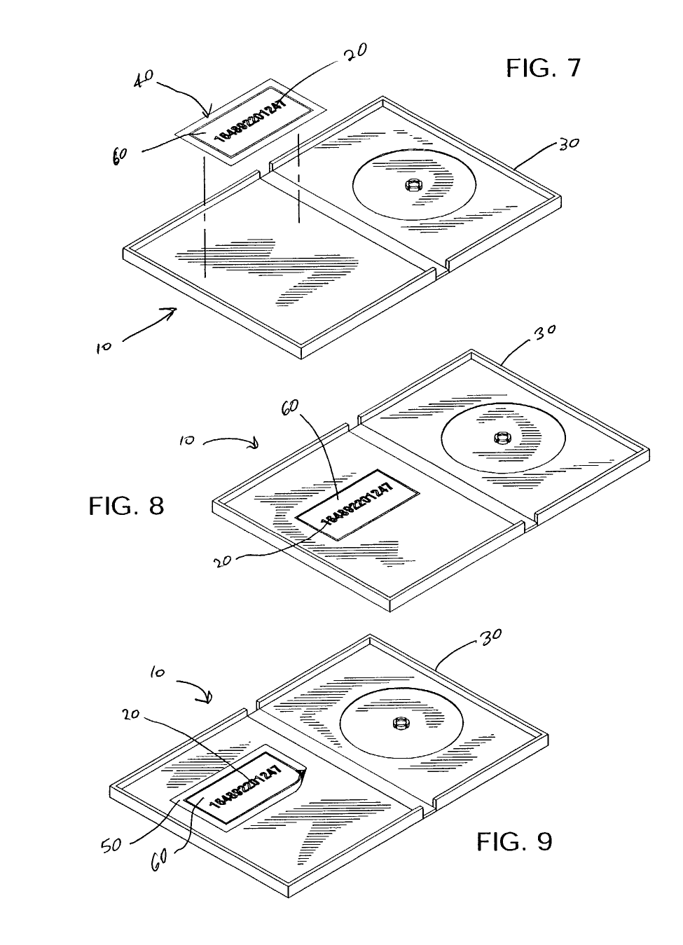

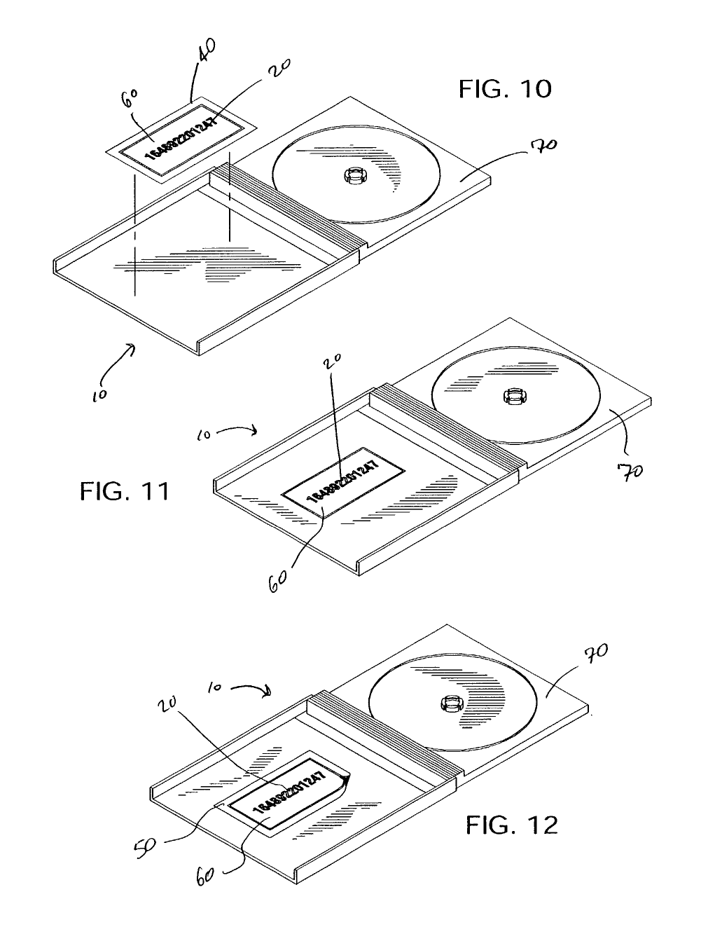

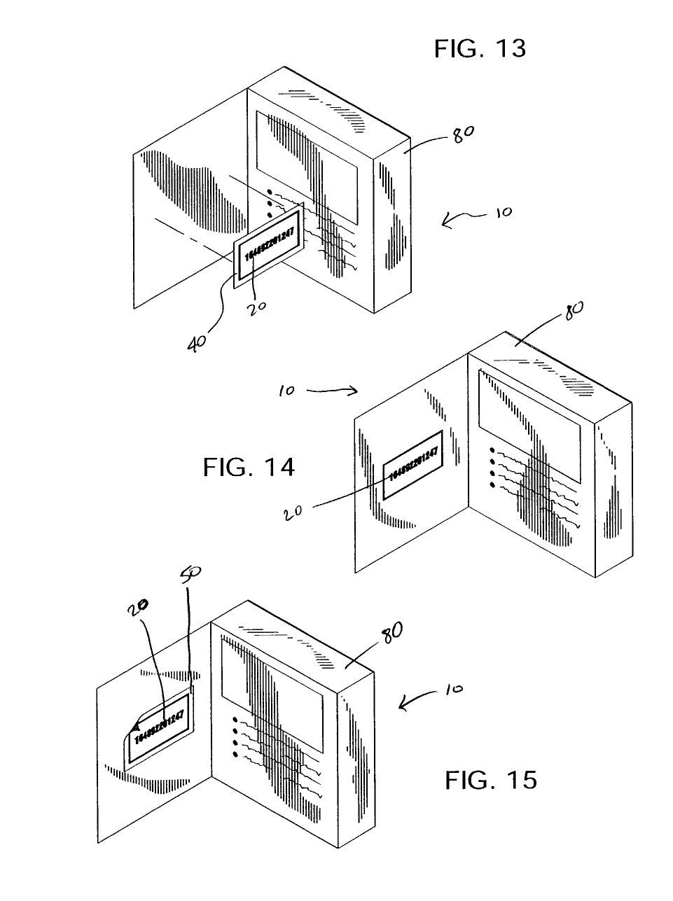

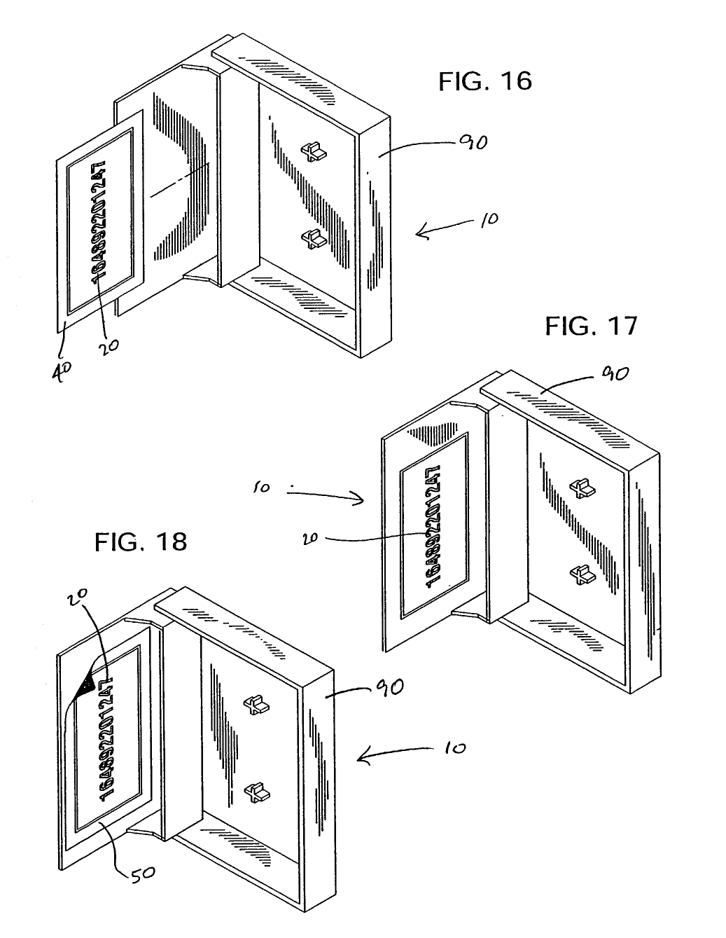

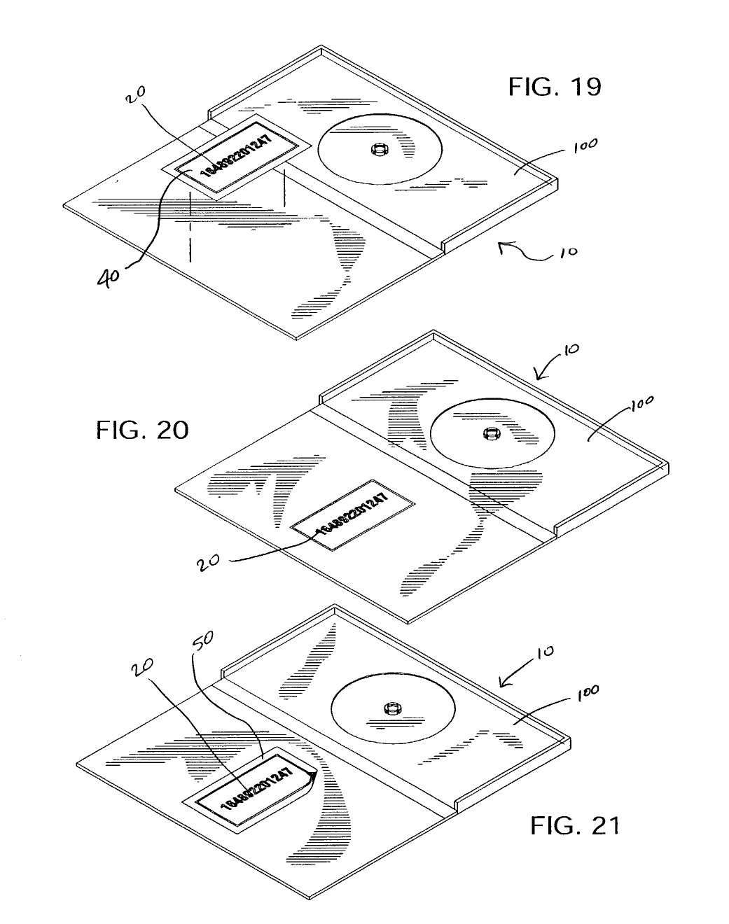

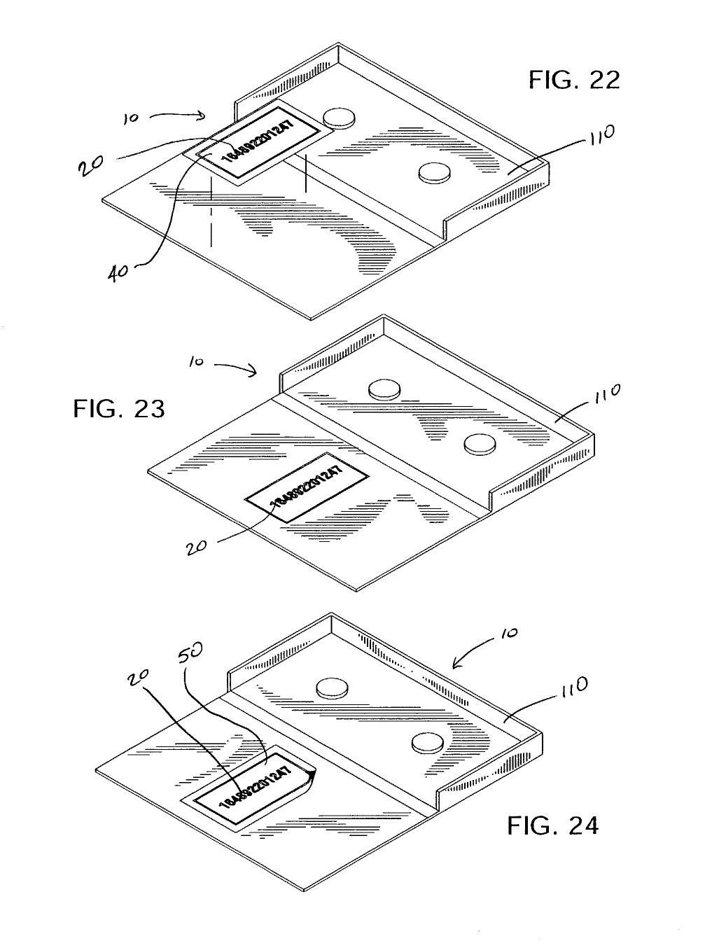

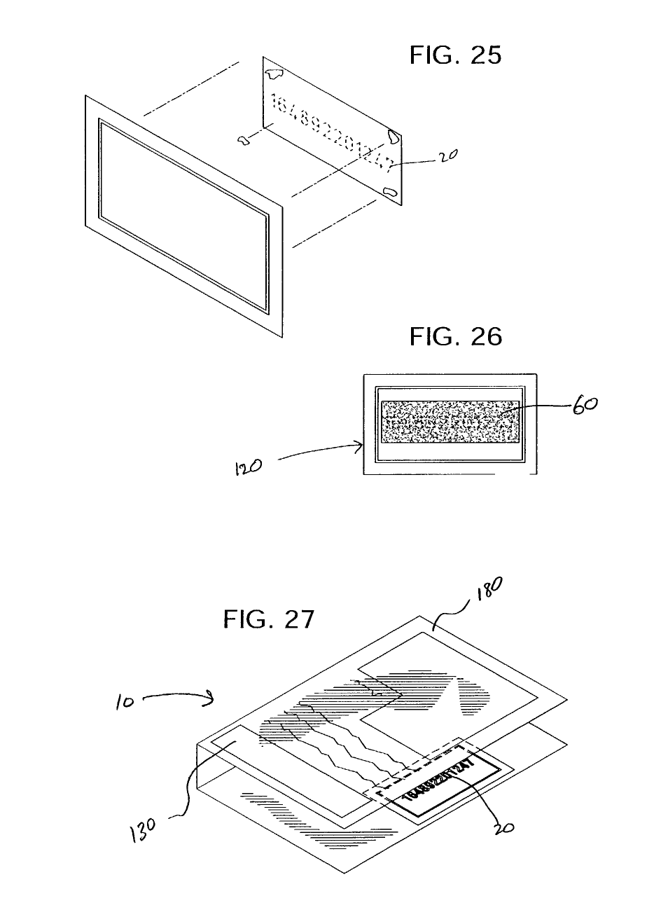

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is an internet access package 10 for retail sale. The package 10 has the appearance of packaging which is generally recognized by consumers as being associated with a particular product. The package 10 is preferably sold in a retail store in a section of the store in which products to which the package relates are sold.

The package 10 includes an access code 20 packaged in conjunction with the packaging which is accessible to a consumer after the package is purchased. The access code 20 enables such a consumer to access a restricted access site on a computer network, such as the internet.

The access code 20 may be any type of code which can provide access to a site. For example, it could be an alphanumeric code, a bar code, a URL, a code encompassed in electronic media, a user name, a password, a combination of any of the above, etc. Regardless of the form of the code 20, the code 20 must provide access to a restricted access site.

In a preferred embodiment, the access code 20 provides access to the restricted site for a limited, set period of time. This period of time may commence upon the consumer signing into the site with the code 20 for the first time. Alternatively, set dates of activation may be used, or point of purchase activation may be used.

Preferably, the restricted access site is associated with the particular product, meaning there is some connection between the subject matter of the site and the particular product. Ideally, the restricted access site enables the consumer to access an internet product related to said particular product. In one preferred embodiment, the particular product which is associated with the packaging is not contained within the packaging. Thus, a consumer in a retail store who is interested in purchasing a particular product may see the packaging associated with that particular product and then take an interest in the online version which is related to that product. Access may be provided to webcasts, audio or video streams, rebroadcasts of shows, online magazines, etc.

One embodiment of the invention is a DVD box 30. The DVD box 30 is has the appearance of a DVD box typically used to package a DVD product. Preferably, no DVD product is contained within the box 30. The access code 20 is included with the DVD box 30, preferably inside the box 30. In one preferred embodiment, the access code 20 enables the consumer to access a restricted access site containing video material or movies for viewing or downloading. Optionally, the consumer is enabled to download a limited number of video products.

While any suitable mode of including the access code 20 within the packaging for any of the embodiments herein is contemplated, several preferred manners of including the access code 20 are as follows. In one embodiment, the access code 20 is placed within the packaging as an insert 40. The insert 40 may be any suitable article sized to fit within the packaging and containing an access code 40. Card stock, paper, cards, credit card size cards 120, etc., are examples, but are not intended to be limiting. The access code 20 may be printed or applied directly on the insert 40, or it may be attached to it via attachment means such as an adhesive label or other suitable means.

Alternatively, the access code 20 may be printed or applied directly on an inner surface of the packaging. In another embodiment, the access code 20 may be applied to an adhesive label 50 which is adhered to a surface of the packaging.

Additional advertising material may be present within the packaging. Also the particular product or a portion thereof may also be included within the packaging.

In any of the embodiments herein, the access code 20 is optionally veiled by scratch-off material 60.

In one embodiment, the packaging is a CD case 70 or “jewel” case. Optionally, the CD case does not contain a CD product. Preferably, the consumer is enabled to download or listen to an audio product such as a music product. In another preferred embodiment, the consumer is enabled to download a custom music product by selecting a plurality of music selections. In this manner, a CD or other recording media can be created containing only those selections desired by the consumer rather than a packaged set of selections. This can be done via MP3 technology or any other suitable means for downloading and saving or listening to musical selections. The musical selections could be in the form of a webcast or audio stream.

In another preferred embodiment, the packaging is a software box 80. Preferably no software product is contained within the software box 80. The consumer preferably is enabled to access a restricted access site in this embodiment which contains software products which can be downloaded or otherwise utilized by the consumer.

In a further preferred embodiment, the packaging is an audio cassette case 90. Preferably, no cassette product is contained within the cassette box 90. Preferably, the consumer is enabled to download or listen to an audio product such as a music product. In another preferred embodiment, the consumer is enabled to download a custom music product by selecting a plurality of music selections. In this manner, a CD or other recording media can be created containing only those selections desired by the consumer rather than a packaged set of selections. This can be done via MP3 technology or any other suitable means for downloading and saving or listening to musical selections.

In still a further preferred embodiment, the packaging is a language education case 100 such as would normally hold a program for language instruction which might be software, audio or video recordings, or text. Preferably, no such product is contained within the case 100. Preferably, the access code 20 enables the user to access or download a foreign language (meaning language other than the consumer's native tongue) instruction product.

In yet a another preferred embodiment of the invention, the packaging is a video cassette case 110. Preferably, no video cassette product is contained within the case 110. Ideally, the access code 20 enables the consumer to access or download a video product such as one or more movies.

In another embodiment, the access code 20 of the invention enables the user to download or access a fixed number of items. These items could be musical selections, software products, video products, audio products, or online text products.

In yet a further embodiment, the invention comprises a package which includes an outer cover having the appearance of a cover for a printed material product, and an access code 20 packaged in conjunction with the outer cover 130. The access code 20 enables a consumer to access a restricted access site on a computer network such as the internet. The access code 20 is disposed within the outer cover 130 in the same manners described above.

In one aspect of this embodiment, the outer cover 130 has the appearance of a magazine cover 140. The cover 140 may contain no interior pages or may contain one or more interior pages 150. Optionally, advertising material 160 may be included within the magazine cover 140. The package 10 is preferably sold at a magazine stand in a retail store, and is optionally contained within shrink wrap type packaging 170 to protect its content from view prior to purchase. In this embodiment, the access code 20 preferably provides access to an online magazine. Ideally, the online magazine would relate directly to subject matter referenced on the cover 140. The code 20 may provide access for a limited set period of time, such as thirty days from first access. In another aspect of this embodiment, the restricted access site enables the consumer to access a webcast or audio or video stream which relates to subject matter contained on the outer cover 140. For example, a magazine cover 140 might reference music of a particular type, and access may be given to an audio stream or webcast of music of the same type.

In another aspect of this embodiment, the outer cover 130 has the appearance of a book cover 180. The cover 180 may contain no interior pages or may contain one or more interior pages. Optionally, advertising material may be included within the book cover 180. The package 10 is preferably sold at a book stand in a retail store, and is optionally contained within shrink wrap type packaging to protect its content from view prior to purchase. In this embodiment, the access code 20 preferably provides access to an online book. Ideally, the online book would relate directly to subject matter referenced on the cover 180. The code 20 may provide access for a limited set period of time, such as thirty days from first access. Alternatively, it may allow a consumer to view or download one online product or a set number of online products, such as online books.

The present invention also encompasses a method for packaging and providing access to a restricted access site on a computer network. The method includes the steps of providing a package 10 having the appearance of packaging which is generally recognized by consumers as being associated with a particular product, and providing an access code 20 packaged in conjunction with the packaging which is accessible to a consumer after the package is purchased, wherein the access code enables such a consumer to access a restricted access site on a computer network. Preferably, the restricted access site enables such a consumer to access an internet product related to the particular product. Ideally, the package 10 is sold in a retail store in a section of the store which is used to sell the particular product.

The method preferably includes the step of providing the consumer with access to the site for a limited set period of time.

In a preferred embodiment of the invention, the method further includes the step of periodically updating the site with a frequency which is at a faster rate than the limited set period of time, so that new material is added during the activation period provided by the access code 20. Preferably, material from the site which has been available on the site for a second period of time is deleted. For example, material which is as old as the set period of time could be deleted, such as in thirty days.

In another embodiment of the invention, the invention provides a method for enabling the downloading of electronic selections. The method comprises the steps of providing an online computer network site having a plurality of electronic selections available for downloading, each of the selections having a point value associated therewith. Additionally, the method includes the step of allowing a consumer to purchase the right to download selections wherein a total point value is allotted to the consumer and wherein the consumer is enabled to download a maximum quantity of selections determined by the total point value as a sum of the point values associated with each of said selections.

Preferably, the selections are musical selections such as songs or pieces of music. Preferably, an access code 20 is sold in a retail package wherein the access code 20 provides the user with the ability to enter the site and download the maximum quantity of selections. Ideally, the retail package has the appearance of packaging which is generally recognized by consumers as being associated with a particular product. Preferably, the product is a recorded music product such as a CD case. Optionally, the CD case contains a CD, such as a blank CD for utilization in downloading and storing the electronic selections.

A product according to this embodiment is further disclosed which is an internet access package for retail sale. The package is a package having the appearance of packaging which is generally recognized by consumers as being associated with a particular product, and an access code 20 packaged in conjunction with the packaging which is accessible to a consumer after the package is purchased. The access code 20 enables such a consumer to download a maximum quantity of electronic selections from a computer network site.

The maximum quantity is preferably determined by providing the consumer with a fixed maximum point value. The site makes available a plurality of electronic selections, each of the selections having a point value associated therewith. The maximum quantity is determined by allowing the consumer to choose selections whose point values sum to arrive at a total point value no higher than the fixed maximum point value. For example, a consumer may purchase access to fifty points worth of selections. Each selection may have the same or different point values associated therewith. The consumer could select any number of selections so long as the total point value does not exceed fifty. The consumer may optionally be enabled to download selections having zero point value.

In one preferred embodiment, the package has the appearance of a package associated with a recorded music product such as a CD. Optionally, the CD case contains a CD such as a blank CD onto which the downloaded selections can be recorded.

While the specific embodiments have been illustrated and described, numerous modifications come to mind without significantly departing from the spirit of the invention, and the scope of protection is only limited by the scope of the accompanying claims.

What is claimed is:

1. An internet access package for retail sale comprising:
a package having the appearance of packaging which is generally recognized by consumers as being associated with a particular product, and
an access code packaged in conjunction with said packaging which is accessible to a consumer after said package is purchased, wherein said access code enables such a consumer to access a restricted access site on a computer network.

2. The internet access package according to claim 1, wherein said access code provides access to said restricted access site for a set period of time.

3. The internet access package according to claim 2, wherein said set period of time commences upon such a consumer accessing said restricted access site for a first time using said access code.

4. The internet access package according to claim 1, wherein said restricted access site is associated with said particular product.

5. The internet access package according to claim 1, wherein said restricted access site enables such a consumer to access an internet product related to said particular product.

6. The internet access package according to claim 5, wherein said particular product is not contained within said packaging.

7. The internet access package according to claim 1, wherein said packaging is a DVD box.

8. The internet access package according to claim 7, wherein said access code is disposed on an insert, said insert being disposed within said DVD box.

9. The internet access package according to claim 7, wherein said access code is disposed on an adhesive label, said adhesive label being disposed within said DVD box.

10. The internet access package according to claim 7, wherein said access code is disposed directly on an inside surface of said DVD box.

11. The internet access package according to claim 7, wherein said access code is veiled via scratch-off material.

12. The internet access package according to claim 7, wherein said restricted access site enables the consumer to download or view a video product.

13. The internet access package according to claim 7, wherein said DVD box does not contain a DVD.

14. The internet access package according to claim 1, wherein said packaging is a CD case.

15. The internet access package according to claim 14, wherein said access code is disposed on an insert, said insert being disposed within said CD case.

16. The internet access package according to claim 14, wherein said access code is disposed on an adhesive label, said adhesive label being disposed within said CD case.

17. The internet access package according to claim 14, wherein said access code is disposed directly on an inside surface of said CD case.

18. The internet access package according to claim 14, wherein said access code is veiled via scratch-off material.

19. The internet access package according to claim 14, wherein said restricted access site enables the consumer to download or hear an audio product.

20. The internet access package according to claim 14, wherein said restricted access site enables the consumer to download or hear an audio music product.

21. The internet access package according to claim 14, wherein said restricted access site enables the consumer to download a custom music product by selecting a plurality of music selections.

22. The internet access package according to claim 14, wherein said CD case does not contain a CD.

23. The internet access package according to claim 1, wherein said packaging is a software box.

24. The internet access package according to claim 23, wherein said access code is disposed on an insert, said insert being disposed within said software box.

25. The internet access package according to claim 23, wherein said access code is disposed on an adhesive label, said adhesive label being disposed within said software box.

26. The internet access package according to claim 23, wherein said access code is disposed directly on an inside surface of said software box.

27. The internet access package according to claim 23, wherein said access code is veiled via scratch-off material.

28. The internet access package according to claim 23, wherein said restricted access site enables the consumer to download a software product.

29. The internet access package according to claim 23, wherein said software box does not contain a software product.

30. The internet access package according to claim 1, wherein said packaging is an audio cassette case.

31. The internet access package according to claim 30, wherein said access code is disposed on an insert, said insert being disposed within said audio cassette case.

32. The internet access package according to claim 30, wherein said access code is disposed on an adhesive label, said adhesive label being disposed within said audio cassette case.

33. The internet access package according to claim 30, wherein said access code is disposed directly on an inside surface of said audio cassette case.

34. The internet access package according to claim 30, wherein said access code is veiled via scratch-off material.

35. The internet access package according to claim 30, wherein said restricted access site enables the consumer to download or hear an audio product.

36. The internet access package according to claim 30, wherein said restricted access site enables the consumer to download or hear an audio music product.

37. The internet access package according to claim 30, wherein said audio cassette case does not contain an audio cassette product.

38. The internet access package according to claim 1, wherein said packaging is a foreign language education case.

39. The internet access package according to claim 38, wherein said access code is disposed on an insert, said insert being disposed within said foreign language education case.

40. The internet access package according to claim 38, wherein said access code is disposed on an adhesive label, said adhesive label being disposed within said foreign language education case.

41. The internet access package according to claim 38, wherein said access code is disposed directly on an inside surface of said foreign language education case.

42. The internet access package according to claim 38, wherein said access code is veiled via scratch-off material.

43. The internet access package according to claim 38, wherein said restricted access site enables the consumer to download or access a foreign language education product.

44. The internet access package according to claim 38, wherein said foreign language education case does not contain a foreign language education product.

45. The internet access package according to claim 1, wherein said packaging is a video cassette case.

46. The internet access package according to claim 45, wherein said access code is disposed on an insert, said insert being disposed within said video cassette case.

47. The internet access package according to claim 45, wherein said access code is disposed on an adhesive label, said adhesive label being disposed within said video cassette case.

48. The internet access package according to claim 45, wherein said access code is disposed directly on an inside surface of said video cassette case.

49. The internet access package according to claim 45, wherein said access code is veiled via scratch-off material.

50. The internet access package according to claim 45, wherein said restricted access site enables the consumer to download or view a video product.

51. The internet access package according to claim 45, wherein said video cassette case does not contain a video cassette product.

52. The internet access package according to claim 1, wherein said access code is disposed on an adhesive label which is adhered to an insert.

53. The internet access package according to claim 52, wherein said insert is a credit card type card.

54. The internet access package according to claim 1, wherein said access code is disposed directly on an insert.

55. The internet access package according to claim 54, wherein said insert is a credit card type card.

56. The internet access package according to claim 55, further comprising scratch-off material veiling said access code.

57. The internet access package according to claim 1, wherein said restricted access site enables the consumer to access a webcast.

58. The internet access package according to claim 1, wherein said restricted access site enables the consumer to access an audio or video stream.

59. The internet access package according to claim 58, wherein said stream is a rebroadcast of a program.

60. The internet access package according to claim 1, wherein said access code enables the consumer to download a fixed number of items.

61. The internet access package according to claim 14, wherein said access code enables the consumer to download a fixed number of music selections.

62. An internet access package for retail sale comprising:
an outer cover having the appearance of a cover for a printed material product, and
an access code packaged in conjunction with said outer cover wherein said access code enables a consumer to access a restricted access site on a computer network.

63. The internet access package according to claim 62, wherein said outer cover has the appearance of a magazine cover.

64. The internet access package according to claim 63, wherein said access code is disposed on an insert, said insert being disposed within said outer cover.

65. The internet access package according to claim 63, wherein said access code is disposed on an adhesive label, said adhesive label being disposed within said outer cover.

66. The internet access package according to claim 63, wherein said access code is disposed directly on an inside surface of said outer cover.

67. The internet access package according to claim 63, wherein said access code is veiled via scratch-off material.

68. The internet access package according to claim 63, wherein said restricted access site enables the consumer to download or view an online magazine.

69. The internet access package according to claim 68, wherein said access code enables the consumer to access said site for a fixed time period.

70. The internet access package according to claim 68, wherein said outer cover contains reference to particular subject matter, and wherein said online magazine is related to said particular subject matter.

71. The internet access package according to claim 62, wherein said outer cover has the appearance of a book cover.

72. The internet access package according to claim 71, wherein said restricted access site enables the consumer to download or view an online book.

73. The internet access site according to claim 63, wherein said restricted access site enables the consumer to access a webcast or audio or video stream which relates to subject matter contained on said outer cover.

74. A method for packaging and providing access to a restricted access site on a computer network comprising the steps of:
providing a package having the appearance of packaging which is generally recognized by consumers as being associated with a particular product, and
providing an access code packaged in conjunction with said packaging which is accessible to a consumer after said package is purchased, wherein said access code enables such a consumer to access a restricted access site on a computer network.

75. The method according to claim 74, wherein said restricted access site enables such a consumer to access an internet product related to said particular product.

76. The method according to claim 75, further comprising the step of selling said package in a retail store in a section of said store which is used to sell said particular product.

77. The method according to claim 75, further comprising the step of providing the consumer with access to said site for a limited set period of time.

78. The method according to claim 77, further comprising the steps of:
periodically updating said site with a frequency which is at a faster rate than said limited set period of time, and
deleting material from said site which has been available on said site for a second period of time.

79. A method for enabling the downloading of electronic selections comprising the steps of:
providing an online computer network site having a plurality of electronic selections available for downloading, each of said selections having a point value associated therewith,
allowing a consumer to purchase the right to download selections wherein a total point value is allotted to the consumer and wherein the consumer is enabled to download a maximum quantity of selections determined by the total point value as a sum of the point values associated with each of said selections.

80. The method according to claim 79, wherein said selections are musical selections.

81. The method according to claim 80, wherein the step of allowing a consumer to purchase the right to download selections is performed by selling a retail package having an access code included therewith wherein said access code provides the user with the ability to enter said site and download said maximum quantity of selections.

82. The method according to claim 81, wherein said retail package has the appearance of packaging which is generally recognized by consumers as being associated with a particular product.

83. The method according to claim 82, wherein said package has the appearance of a package generally recognized by consumers as being associated with a recorded music product.

84. The method according to claim 83, wherein said package has the appearance of a CD case.

85. The method according to claim 84, wherein said package contains a CD therein.

86. An internet access package for retail sale comprising:
a package having the appearance of packaging which is generally recognized by consumers as being associated with a particular product, and
an access code packaged in conjunction with said packaging which is accessible to a consumer after said package is purchased, wherein said access code enables such a consumer to download a maximum quantity of electronic selections from a computer network site.

87. The internet access package according to claim 86, wherein said maximum quantity is determined by providing the consumer with a fixed maximum point value, and wherein said site makes available a plurality of electronic selections, each of said selections having a point value associated therewith, said maximum quantity being determined by allowing the consumer to choose selections whose point values sum to arrive at a total point value no higher than the fixed maximum point value.

88. The internet access package according to claim 87, wherein said package has the appearance of a package generally recognized by consumers as being associated with a recorded music product.

89. The internet access package according to claim 88, wherein said package has the appearance of a CD case.

90. The internet access package according to claim 89, wherein said package contains a CD therein.
